(19) United States
(12) Patent Application Publication
(10) Pub. No.: US 2008/0271123 A1
(43) Pub. Date: Oct. 30, 2008

(54) System and Method For Controlling Devices in a Home-Automation Network

(75) Inventors: Jeffrey D. Ollis, Dresher, PA (US); Michael R. Wimberly, Sammamish, WA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/742,237

(22) Filed: Apr. 30, 2007

(51) Int. Cl. H04L 9/32; G06F 17/00

(52) U.S. Cl. 726/4; 700/90

(57) ABSTRACT

A home-automation system (108) and method (300) for controlling at least one device of a plurality of devices in a home-automation network (104) are disclosed. The home-automation system includes a receiver (202) configured to receive a signal indicative of location a user. The user is located beyond the proximity of the home being automated by the home-automation network. The home-automation system also includes a processor (208) adapted to control the at least one device of the plurality of devices in response to the received indicative signal.

### FIELD OF THE INVENTION

This invention relates in general to home-automation networks, and more specifically, to a system and method for controlling devices in a home-automation network.

### BACKGROUND OF THE INVENTION

The concept of automation has existed for many years. Automation is the technique of making a process, machine or mechanism self-acting, self-moving or self-controlling. The success of industrial automation was followed by home automation, which led to the concept of home-automation systems.

Home-automation systems can control one or more devices or elements, for example, lighting devices, doors, window shutters, security and surveillance systems, and the like, to enhance safety, security, comfort and convenience. The increased usage of home-automation systems has made people feel more secure, since the home-automation systems can control various appliances and security mechanisms. For example, if a user forgets to lock his/her doors while leaving the house, the home-automation system automatically locks them after the user leaves.

Further, contemporary home-automation systems can control various appliances in the home-automation network, based on the location of a user within the home. For example, the lights and air-conditioner of a room can be switched on by the home-automation system as soon as the user enters the room. Further, as the user moves from the bedroom to the living room, the lights can be switched off in the bedroom, and the lights and music system can be switched on in the living room. However, the functions of contemporary home-automation systems are limited to the home.

### BRIEF DESCRIPTION OF DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary network, where various embodiments of the present invention can be practiced;

FIG. 2 illustrates a block diagram of a home-automation system, in accordance with an embodiment of the present invention;

FIG. 3 is a flow diagram illustrating a method for controlling at least one device of a plurality of devices in a home-automation network, in accordance with an embodiment of the present invention; and

FIG. 4 is a flow diagram illustrating another method for controlling at least one device of a plurality of devices in a home-automation network, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

For one embodiment, a system for controlling at least one device of a plurality of devices in a home-automation network is provided. The system includes a receiver configured to receive a signal indicative of location of a user. The user can be located beyond the proximity of the home being automated by the home-automation network. Further, the system includes a processor adapted to control the at least one device of the plurality of devices within the home-automation in response to the received indicative signal.

For another embodiment, a method for controlling at least one device of a plurality of devices in a home-automation network is provided. The method includes receiving a signal indicative of location of a user. The user can be located beyond the proximity of the home being automated by the home-automation network. The method also includes controlling the at least one device of the plurality of devices in the home-automation network in response to the received indicative signal.

Before describing in detail the particular system and method for controlling devices in a home-automation network, in accordance with various embodiments of the present invention, it should be observed that the present invention utilizes a combination of method steps and apparatus components that are related to the system and method for controlling devices in a home-automation network. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms ‘comprises,’ ‘comprising,’ ‘includes,’ ‘including,’ or any other variation thereof, are intended to cover a non-exclusive inclusion, such that a process, article, system or apparatus that comprises a list of elements does not include only those elements but may include other elements not expressly listed or inherent to such process, article or apparatus. An element preceded by ‘comprises . . . a’ does not, without more constraints, preclude the existence of additional identical elements in the process, article, system or apparatus that comprises the element. The terms ‘includes’ and/or ‘having’, as used herein, are defined as comprising.

The term ‘another,’ as used in this document, is defined as at least a second or more. The term ‘includes’, as used herein, are defined as comprising.

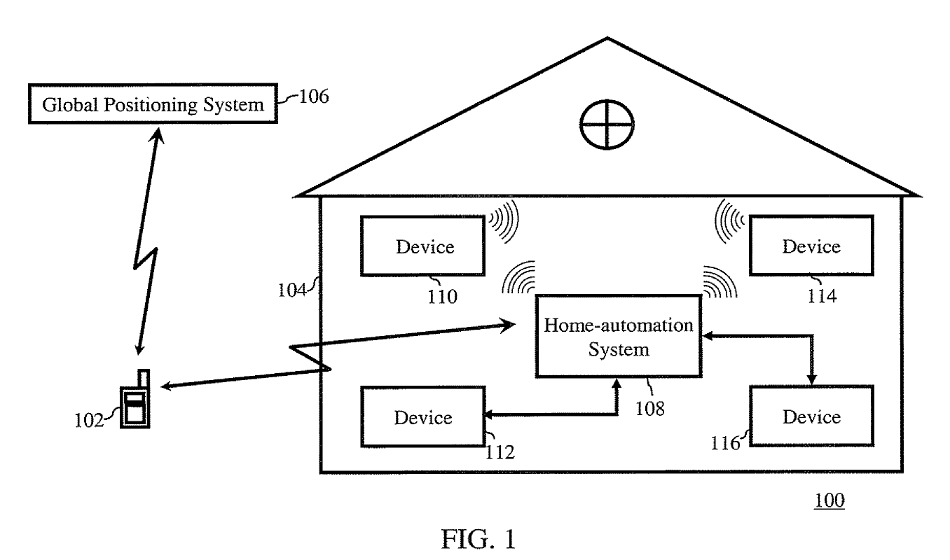

FIG. 1 illustrates an exemplary network 100, where various embodiments of the present invention can be practiced. The network 100 can include a communication device 102 associated with a user, a home-automation network 104, and a Global Positioning System (GPS) 106. Examples of the communication device 102 include, but are not limited to, a cellular phone, a laptop, Personal Digital Assistant (PDA), and a messaging device. For one embodiment, the communication device 102 can be GPS-enabled and can include a GPS receiver (GPSr). In this embodiment, the communication device 102 can receive timing signals from the GPS 106. The timing signals enable any GPSr to accurately determine location of the GPSr (longitude, latitude and altitude) on the globe. Based on the timing signals received from the GPS 106, the communication device 102 determines the geographical location of the user. The home-automation network 104 includes a home-automation system 108, a device 110, a device 112, a device 114, and a device 116. Further, the communication device 102 transmits a signal indicative of the location of the user to the home-automation system 108. The home-automation system 108 can control at least one device of the plurality of devices 110, 112, 114, and 116 based on the indicative signal received from the communication device 102. Examples of the devices 110, 112, 114 and 116 include, but are not limited to, microwave ovens, washing machines, televisions, water heaters, home-theatre systems, music systems, fans, tube lights, air conditioners, and bulbs.

Further, it will be readily apparent to those ordinarily skilled in the art that the home-automation system 108 can interact with the devices 110, 112, 114, and 116 via either a wireless link or a wired link. Examples of the wireless link include, but are not limited to, a Bluetooth link, an Infrared Data Association (IrDA) link, an X-10 link, a Z-Wave link, a ZigBee link and a Wireless Fidelity (WiFi) link. Examples of the wired link can include, but are not limited to, an X-10 link, an Ethernet link, a UPB link, and a HomePlug link.

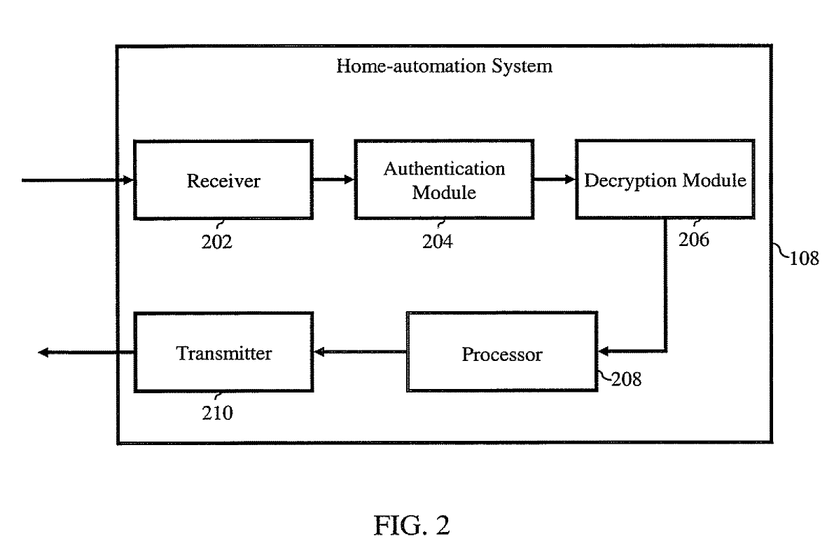

FIG. 2 illustrates a block diagram of a home-automation system 108, in accordance with an embodiment of the present invention. Those skilled in the art would appreciate that the home-automation system 108 may include all or even a fewer number of components than the components shown in FIG. 2. Further, those ordinarily skilled in the art would understand that the home-automation system 108 might include additional components that are not shown here and are not germane to the operation of the home-automation system 108, in accordance with the inventive arrangements. To describe the home-automation system 108, reference will be made to FIG. 1, although it should be understood that the home-automation system 108 can be implemented in any other suitable environment or network.

For one embodiment, the home-automation system 108 can include a receiver 202, an authentication module 204, a decryption module 206, a processor 208, and a transmitter 210. The receiver 202 is be configured to receive the signal from the communication device 102 associated with the user. For one embodiment, the user can be located beyond the proximity of the home being automated by the home-automation network 104. For example, consider a scenario in which the user is coming back from the office and wants the air-conditioner to be turned on in advance, so that the room cools to the desired temperature before the user reaches home. In this scenario, the user can configure the home-automation system 108 to switch on the air-conditioner when he/she reaches a particular location, for instance, a particular traffic signal, while driving back from the office to the home. For another embodiment, the user can be located within the home-automation network 104 being automated by the home-automation system 108. For example, consider a scenario in which the user is within the home-automation network 104 and is busy gardening. The user wants to switch on the microwave oven and switch off the sprinkler in the garden when the user reaches a particular location in the home, for example, the staircase. In this scenario, the user can configure the home-automation system 108 to switch on the microwave oven and switch off the sprinkler in the garden when the user reaches the staircase.

The signal received from the communication device 102 can be indicative of location of the user. For one embodiment, the indicative signal can include information related to the geographic location of the user. For example, the indicative signal received from the communication device 102 can include a GPS signal. Further, the indicative signal can be based on the timing signals received from the GPS 106. In one arrangement of this embodiment, the indicative signal can include information related to heading and speed of the user. For example, the indicative signal can include the current location of the user and the speed at which the user is approaching home. Knowing the location of and the speed at which a user is driving can be useful when the user is stuck in a traffic jam and wants the desired devices to be switched on, based on the expected time required by the user to reach home. The expected time can be calculated, based on the speed at which the user is driving and the current location of the user.

For one embodiment, the indicative signal can be received periodically from the communication device 102. In one arrangement of this embodiment, the communication device 102 can directly transfer the timing signals received from the GPS 106 to the home-automation system 108. In this arrangement, the home-automation system 108 can process the timing signals. In another arrangement of this embodiment, the communication device 102 processes the timing signals received from the GPS 106 to obtain an indicative signal, based on the timing signals received from the GPS 106. Further, the communication device 102 periodically sends the indicative signal to the home-automation system 108. The time gap between two subsequent indicative signals received from the communication device 102 can be dependent on the time gap between two subsequent timing signals received from the GPS 106 at the communication device 102.

For another embodiment, the indicative signal can be received only when a predetermined condition is met. The predetermined condition can include a condition that the geographical location of the user is within a particular distance from the home being automated by the home-automation network 104. For example, the indicative signal can be received when the user, while coming back home, reaches a geographical location which is within a particular distance from the home, for example, when the user reaches a location, which is within two miles from the home. The particular distance can be modified by the user, based on the requirements of the user. Further, the predetermined condition can include a particular location with respect to the location of the home being automated by the home-automation network 104. For example, the indicative signal can be received when the user, while coming back home, reaches a particular geographical location, for example, a particular traffic light or landmark.

After the indicative signal from the communication device 102 is received by the receiver 202, the authentication module 204 can authenticate the indicative signal received from the communication device 102. The authentication of the indicative signal ensures the implementation of better security standards and the authenticity of the user. The indicative signal can be authenticated, based on a code or a Personal Identification Number (PIN) entered by the user on the communication device 102. Further, the International Mobile Equipment Identity (IMEI) of the communication device 102 can be transmitted with the indicative signal, to authenticate the indicative signal.

For another embodiment, an improved standard of security can be implemented by the use of the indicative signal encrypted at the communication device 102. In this embodiment, the encrypted indicative signal received from the communication device 102 is decrypted by the decryption module 206. The indicative signal can be encrypted and decrypted by using any of the known techniques and algorithms, for example, a Pretty Good Privacy (PGP) and public-private encryption techniques. Those skilled in the art would appreciate that the authentication module 204 and decryption module 206 can be implemented as a hardware module as well as a software module.

After the indicative signal has been authenticated and decrypted by the authentication module 204 and the decryption module 206 respectively, the processor 208 can control at least one device of the plurality of devices 110, 112, 114 and 116 within the home-automation network 104, in response to the received indicative signal. For one embodiment, the processor 208 can be adapted to respond to the received indicative signal that meets a predetermined condition. In this embodiment, the processor 208 can be configured to execute a predefined set of instructions within the home-automation network 104. The execution is initiated in response to the received indicative signal that meets a predetermined condition. The predefined set of instructions can include information for controlling the at least one device of the plurality of devices 110, 112, 114, and 116 in the home-automation network 104. The predefined set of instructions can be modified by the user based on the requirements of the user. The user can modify the predefined set of instructions to control the devices 110, 112, 114, and 116, as desired by the user. For one embodiment, the user can modify the predefined set of instructions by sending a message to the home-automation system 108 from the communication device 102. For another embodiment, the user can modify the predefined set of instructions by manually providing the predefined set of instructions at the home-automation system 108. For example, the user can punch the predefined set of instructions at the home-automation system 108, through a keypad or an interface available on the home-automation system 108.

For one embodiment, the predetermined condition can be that the geographical location of the user is within a particular distance from the home being automated by the home-automation network 104. In this embodiment, the execution of the predefined set of instructions can be initiated when the geographical location of the user is within a particular distance, for instance, one mile, from the home. The particular distance can be modified by the user, based on the requirements of the user. For example, consider a scenario in which the user is coming back from his/her office and wants to switch on the microwave oven in order to warm the food kept inside the microwave oven. The user can configure the home-automation system 108 to switch on the microwave oven when the user is within a radius of one mile from home. In this scenario, irrespective of the route the user takes to return home, the microwave oven will be switched on when the user is within a radius of one mile from home. In this way, the user will be able to get warm food when the user reaches home.

For another embodiment, the predetermined condition can include the geographic location of the user is a particular location with respect to the location of the home being automated by the home-automation network 104. In this embodiment, the execution of the predefined set of instructions can be initiated when the user reaches a particular geographical location, for instance, a particular traffic signal. For example, consider a scenario in which the user is coming back from his/her friend's place and wants to switch on the room heater, to come home to a warm room. The user can configure the home-automation system 108 to switch on the room heater when the user reaches a particular landmark. In this scenario, the route taken by the user to reach home is important, since the execution of the predefined set of instructions will be initiated when the user reaches a particular geographical location. In this way, the user is not required to wait for the room to get warm when the user reaches home.

After the processor 208 has executed the predefined set of instructions, the transmitter 210 can transmit at least one signal to control the at least one device of the plurality of devices 110, 112, 114 and 116 in the home-automation network 104. For one embodiment, the transmitter 210 can transmit the at least one signal in the home-automation network 104 via a wireless link. Examples of the wireless link include, but are not limited to, a Bluetooth link, an Infrared Data Association (IrDA) link, an X-10 link, a Z-Wave link, a ZigBee link, and a Wireless Fidelity (WiFi) link. For another embodiment, the transmitter 210 can transmit the at least one signal in the home-automation network 104 via a wired link. Examples of the wired link can include, but are not limited to, an X-10 link, an Ethernet link, a UPB link and a HomePlug link. For one embodiment, the transmitter 210 can send a text message to the communication device 102, to notify the user that the action desired by the user has been performed. For example, the user can be notified through a text message that the doors have been locked and the security system in the home is working properly every time the user moves out of the home.

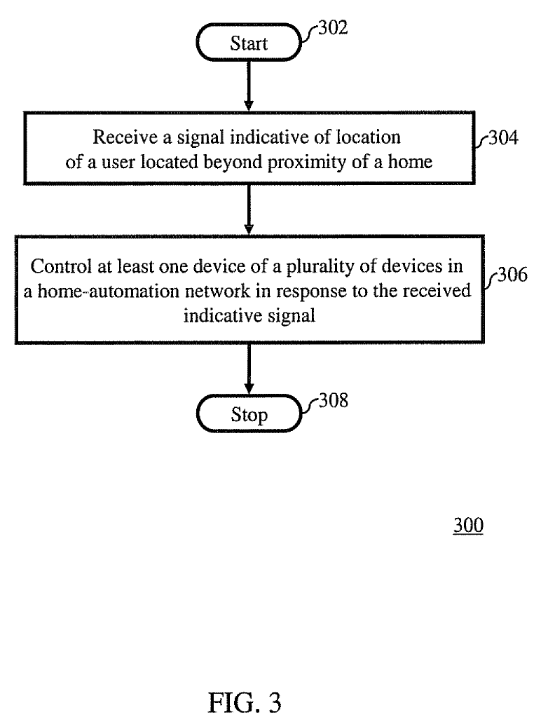

FIG. 3 is a flow diagram illustrating a method 300 for controlling the at least one device of the plurality of devices in the home-automation network 104, in accordance with an embodiment of the present invention. To describe the method 300, reference will be made to FIG. 1, although it is understood that the method 300 can be implemented in any other suitable environment or network. Moreover, the invention is not limited to the order in which the steps are listed in the method 300.

At step 302, the method 300 is initiated. At step 304, the home-automation system 108 can receive the signal indicative of location of the user. The user is located beyond the proximity of the home being automated by the home-automation system 108. For one embodiment, the indicative signal can be received from the communication device 102 associated with the user. The indicative signal received from the communication device 102 includes information related to the geographical location of the user. Examples of the indicative signal received from the communication device 102 include, but are not limited to, a GPS signal. In this embodiment, the indicative signal can include information related to heading and speed of the user. For one arrangement of this embodiment, the indicative signal can be received periodically from the communication device 102. In this arrangement, the communication device 102 can directly transfer the timing signals received from the GPS 106 to the home-automation system 108. For another arrangement of this embodiment, the indicative signal can be received only when the predetermined condition is met.

For one embodiment, the predetermined condition can be met when the geographical location of the user is within a particular distance from the home being automated by the home-automation network 104. For another embodiment, the predetermined condition can include a particular location with respect to the location of the home being automated by the home-automation network 104. In this embodiment, the indicative signal can be received when the user reaches a particular geographical location, for example, a particular traffic light or a particular landmark.

At step 306, the home-automation system 108 can control at least one device of the plurality of devices 110, 112, 114 and 116 in the home-automation network 104, in response to the received indicative signal. For one embodiment, controlling the at least one device of the plurality of devices 110, 112, 114, and 116 can include executing the predefined set of instructions within the home-automation network 104. The predefined set of instructions can include information for controlling the at least one device of the plurality of devices 110, 112, 114, and 116. The execution of the predefined set of instructions can be initiated in response to the received indicative signal, when the received indicative signal meets the predetermined condition. At step 308, the method 300 is terminated.

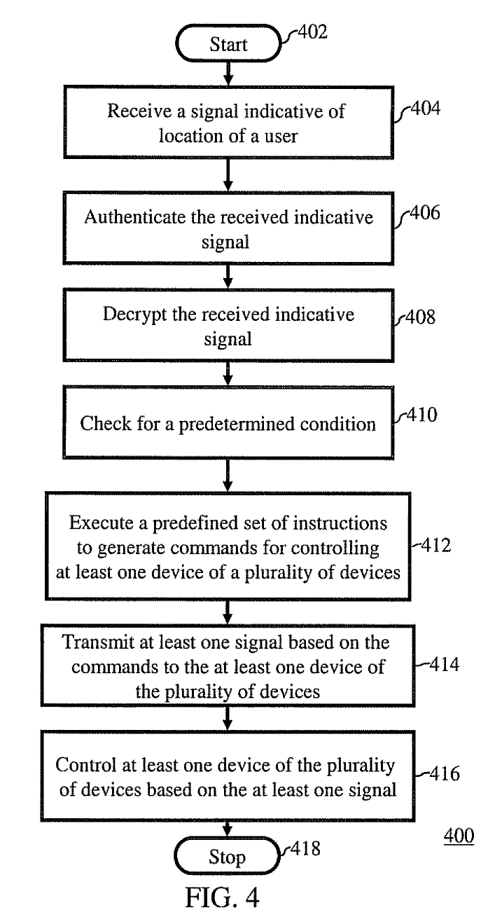

FIG. 4 is a flow diagram illustrating another method 400 for controlling the at least one device of the plurality of devices in the home-automation network 104, in accordance with another embodiment of the present invention. To describe the method 400, reference will be made to FIG. 1, although it is understood that the method 400 can be implemented in any other suitable environment or network. Moreover, the invention is not limited to the order in which the steps are listed in the method 400. Further, the method 400 can contain a greater or fewer numbers of steps than those shown in FIG. 4.

At step 402, the method 400 is initiated. At step 404, the home-automation system 108 can receive the signal indicative of location of the user. The user is located beyond the proximity of the home being automated by the home-automation system 108. The indicative signal can also be received from the communication device 102, which can be associated with the user. The indicative signal received from the communication device 102 can include information related to the geographical location of the user. For one embodiment, the indicative signal can be received periodically from the communication device 102. In this embodiment, the communication device 102 can directly transfer the timing signals received from the GPS 106 to the home-automation system 108. Further, the home-automation system 108 can process the timing signals. For another embodiment, the indicative signal can be received from the communication device 102 only when the predetermined condition is met. The predetermined condition can be met when the geographical location of the user is within a particular distance from the home being automated by the home-automation network 104. Further, the predetermined condition can include the geographic location of the user is a particular location. In this embodiment, the communication device 102 can process the timing signals received from the GPS 106.

At step 406, the indicative signal received from the communication device 102 can be authenticated to ensure authenticity of the user and better security standards. At step 408, the indicative signal, after authentication, can be decrypted to obtain a decrypted indicative signal. At step 410, the predetermined condition is checked. If the predetermined condition is met at step 410, the home-automation system 108 can execute the predefined set of instructions within the home-automation network 104 at step 412. The home-automation system 108 can execute the predefined set of instructions in response to the received indicative signal related to the geographical location of the user. For one embodiment, the predefined set of instructions can be modified by the user, based on the needs of the user. For example, in this embodiment, the user can modify the set of instructions to change the settings of the devices in the home-automation network 104. Further, the user can send a modified set of instructions through the communication device 102 to the home-automation system 108.

For one embodiment, the home-automation system 108 can execute the predefined set of instructions to generate commands for controlling at least one device of the plurality of devices 110, 112, 114 and 116, in response to the received indicative signal. At step 414, the home-automation system 108 can transmit at least one signal, based on the commands for controlling at least one device of the plurality of devices 110, 112, 114, and 116, to at least one device of the plurality of devices 110, 112, 114 and 116. For one embodiment, the at least one signal can be transmitted via a wireless link. For another embodiment, the at least one signal can be transmitted via a wired link. At step 416, the at least one device of the plurality of devices 110, 112, 114 and 116 can be controlled, based on the at least one signal indicative of the commands for controlling the at least one device of the plurality of devices 110, 112, 114 and 116. In an embodiment, the controlling at least one device of the plurality of devices can be predicated upon the received indicative signal meeting the predetermined condition. At step 418, the method 400 is terminated.

Various embodiments, as described above, provide a system and method for controlling devices in the home-automation network. The present invention enables the user to control devices in the home-automation network, even if the user is beyond the proximity of the home. The present invention also provides a secure and safe channel for controlling the devices in the home-automation network.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A system for controlling at least one device of a plurality of devices in a home-automation network, the system comprising:
a receiver configured to receive a signal indicative of location of a user located beyond the proximity of the home being automated by the home-automation network; and
a processor adapted to control the at least one device of the plurality of devices within the home-automation network in response to the received indicative signal.

2. The system of claim 1, wherein the indicative signal comprises information related to the geographical location of the user.

3. The system of claim 2, wherein the indicative signal comprises information related to the heading and speed of the user.

4. The system of claim 1, wherein the indicative signal comprises a Global Positioning System signal.

5. The system of claim 1, wherein the processor is further adapted to respond to the received indicative signal meeting a predetermined condition.

6. The system of claim 5, wherein the predetermined condition comprises a particular location.

7. The system of claim 5, wherein the predetermined condition comprises a particular distance from a home being automated by a home-automation system.

8. The system of claim 1 further comprising a transmitter configured to transmit at least one signal to control the at least one device of the plurality of devices in the home-automation network.

9. The system of claim 1 further comprising a decryption module for decrypting the received indicative signal.

10. The system of claim 1 further comprising an authentication module for authenticating the received indicative signal.

11. A method for controlling at least one device of a plurality of devices in a home-automation network, the method comprising:
receiving a signal indicative of location of a user located beyond the proximity of the home being automated by the home-automation network; and
controlling the at least one device of the plurality of devices within the home-automation network in response to the received indicative signal.

12. The method of claim 11, wherein the indicative signal comprises information related to the geographical location of the user.

13. The method of claim 12, wherein the indicative signal comprises information related to the heading and speed of the user.

14. The method of claim 11, wherein the indicative signal comprises a Global Positioning System signal.

15. The method of claim 11, wherein the step of controlling is predicated upon the received indicative signal meeting a predetermined condition.

16. The method of claim 15, wherein the predetermined condition comprises a particular location.

17. The method of claim 15, wherein the predetermined condition comprises a particular distance from a home being automated.

18. The method of claim 11 further comprising transmitting at least one signal to control the at least one device of the plurality of devices in the home-automation network.

19. The method of claim 11 further comprising the step of decrypting the received indicative signal.

20. The method of claim 11 further comprising the step of authenticating the received indicative signal.
